(19) United States
(12) Patent Application Publication
(10) Pub. No.: US 2012/0009461 A1
(43) Pub. Date: Jan. 12, 2012

(54) Energy storage module

(75) Inventors: Yong Wook Kim, Suwon (KR); Bae Kyun Kim, Seongnam (KR); Young Hak Jeong, Gunpo (KR); Hyun Chul Jung, Yongin (KR)

(73) Assignee: SAMSUNG ELECTRO-MECHANICS CO., LTD., Suwon (KR)

(21) Appl. No.: 12/929,024

(22) Filed: Dec. 22, 2010

(30) Foreign Application Priority Data
Jul. 6, 2010 (KR) 10-2010-0064915

(51) Int. Cl. H01M 2/24; H01M 2/26

(52) U.S. Cl. 429/158

(57) ABSTRACT

An energy storage module formed by electrically connecting a plurality of energy storage cells using terminal connecting members which are resistant to corrosion or external impact is disclosed. The energy storage module includes terminal connection members, each including a first plate having a conductive flat bar shape and terminal insertion holes formed in both ends thereof and at least one second plate having the same shape as the first plate and stacked on the first plate, wherein the first plate has an insulating layer formed on lower surface thereof; and at least two energy storage cells having terminals inserted into the terminal insertion holes of the terminal connection members and electrically connected to each other in series or in parallel by the terminal connection members.

### CROSS-REFERENCE TO RELATED APPLICATIONS

This application claims the priority of Korean Patent Application No. 10-2010-0064915 filed on Jul. 6, 2010, in the Korean Intellectual Property Office, the disclosure of which is incorporated herein by reference.

### BACKGROUND OF THE INVENTION

1. Field of the Invention

The present invention relates to an energy storage module, and more particularly, to an energy storage module formed by electrically connecting a plurality of energy storage cells by using terminal connecting members which are resistant to corrosion or external impact.

2. Description of the Related Art

In general, an energy storage cell is a device or apparatus that stores electrical energy therein to provide the energy to the outside when necessary. Recently, secondary batteries or electric double layer capacitors have been widely used as this energy storage cell.

An energy storage cell includes a storage body for storing energy, and anode and cathode terminals projecting externally from the storage body and electrically connected with current collectors of anode and cathode plates, which are included in the storage body, and so on.

Meanwhile, an energy storage module having a large capacity, formed by connecting a plurality of energy storage cells in series (or in parallel), has been used for machines requiring a high level of power (e.g. electric vehicles, and the like).

As the terminals of the energy storage cells are electrically connected in series or in parallel, the energy storage module has a large energy storage capacity. At this time, the terminals are electrically connected with each other by separate terminal connection members (e.g., bus bars).

This terminal connection member according to the related art, is formed of a single metal plate, and has terminal insertion holes for coupling terminals in both ends of the terminal connection member.

However, as mentioned above, the terminal connection member formed of a single metal plate according to the related art, is easily broken in the case of external impacts or vibrations, or in the case of corrosion, causing short circuits and disconnections within the energy storage module.

### SUMMARY OF THE INVENTION

An aspect of the present invention provides an energy storage module formed by electrically connecting a plurality of energy storage cells using terminal connecting members which are resistant to corrosion or external impact.

According to an aspect of the present invention, there is provided an energy storage module including: terminal connection members, each including a first plate having a conductive flat bar shape and including terminal insertion holes formed in both ends thereof, and at least one second plate having the same shape as the first plate and stacked on the first plate, wherein the first plate has an insulating layer formed on a lower surface thereof; and at least two energy storage cells having terminals inserted into the terminal insertion holes of the terminal connection members and electrically connected to each other in series or in parallel by the terminal connection members.

The insulating layer may be formed on the entire lower surface of the first plate, except for circumferential portions of the terminal insertion holes.

The insulating layer may be formed by applying an insulating material to the lower surface of the first plate.

The insulating layer may be formed by attaching insulation tape to the lower surface of the first plate.

The first and second plates may be formed of different metallic materials.

The first and second plates may be formed such that center portions between the terminal insertion holes upwardly project to be curved in an arc shape.

The energy storage module may further include an insulation cover surrounding the center portions of the first and second plates.

The energy storage module may include at least one third plate having a similar shape to the second plate and interposed between the first plate and the second plate.

The energy storage module may further include a wire coupling portion in the form of protrusion projecting outwardly from a side surface of at least one of the first plate, the second plate, and the third plate.

The energy storage module may further include fixing members which fixedly couple the terminal connection member with the terminals.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing an energy storage module according to an exemplary embodiment of the present invention;

FIG. 2 is an exploded perspective view showing a terminal connection member of FIG. 1;

FIG. 3 is a cross sectional view of the terminal connection member taken along line A-A′ of FIG. 1;

FIG. 4 is a perspective view showing a terminal connection member of an energy storage module according to another exemplary embodiment of the present invention;

FIG. 5 is a cross sectional view showing a terminal connection member of an energy storage module according to another exemplary embodiment of the present invention; and

FIG. 6 is a cross sectional view showing a terminal connection member of an energy storage module according to another exemplary embodiment of the present invention.

### DETAILED DESCRIPTION OF THE PREFERRED EMBODIMENT

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Exemplary embodiments of the present invention will now be described in detail in accordance with the accompanying drawings. In the drawings, the same reference numerals will be used throughout to designate the same or like elements. Also, detailed descriptions with regard to well known functions and configurations, which may obscure the substance of the present invention, will be omitted. For clarity, some elements may be exaggerated or omitted, or may schematically illustrated in the drawings, and the figures are not necessarily drawn to scale.

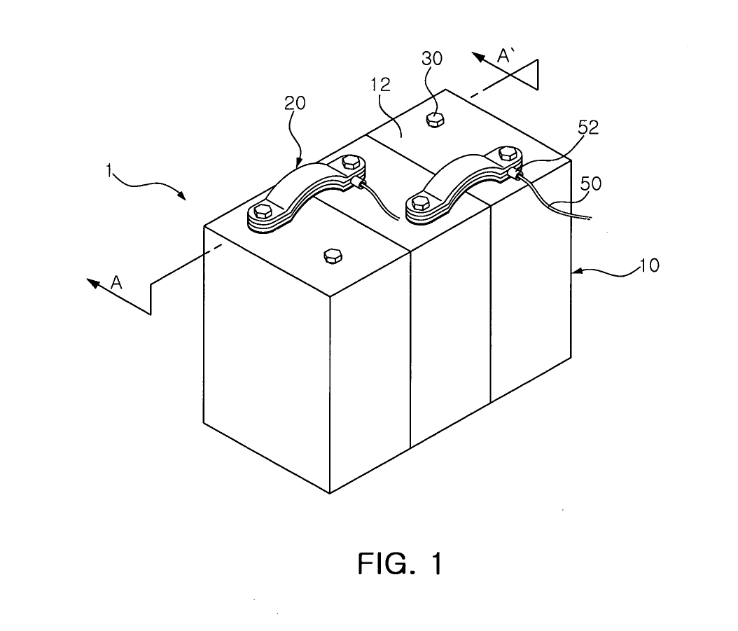

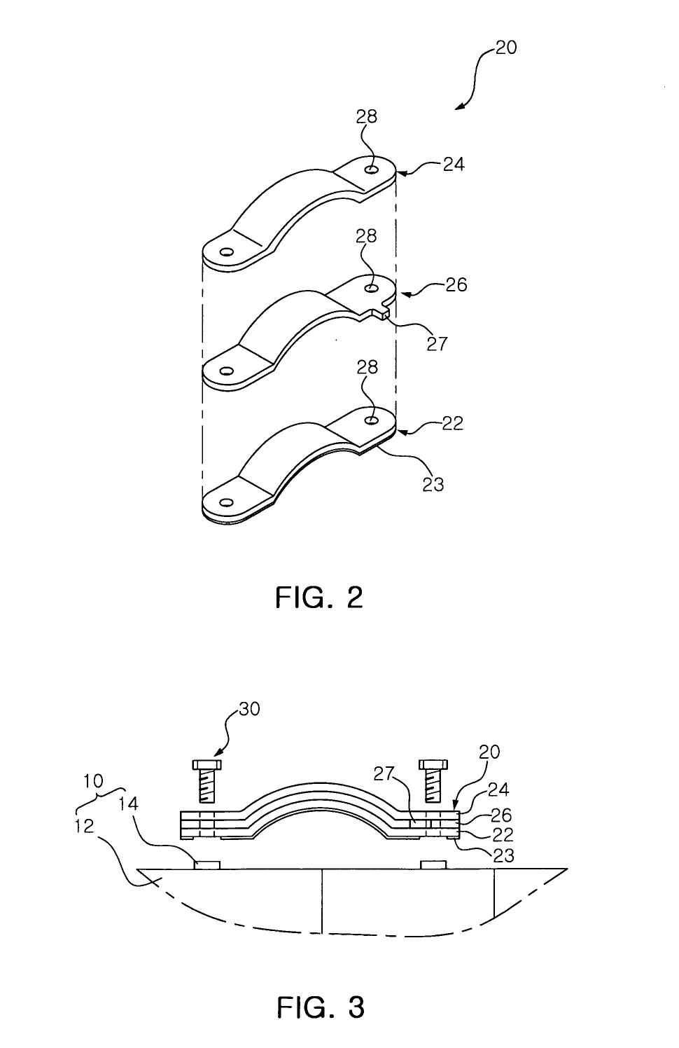

FIG. 1 is a perspective view schematically showing an energy storage module according to an exemplary embodiment of the present invention, FIG. 2 is an exploded perspective view showing a terminal connection member of FIG. 1, and FIG. 3 is a cross sectional view of the terminal connection member taken along line A-A of FIG. 1.

Referring to FIGS. 1 to 3, the energy storage module 1 according to this embodiment includes a plurality of energy storage cells 10, terminal connection members 20, and fixing members 30.

Each of the energy storage cells 10 includes a storage body 12 for storing energy, and terminals 14 (e.g. anode and cathode terminals) projecting externally from the storage body 12 and electrically connected with current collectors (not shown) of anode and cathode plates, which are included in the storage body 12. In the energy storage cells 10 of the embodiment, the terminals 14 have cylindrical coupling grooves (not shown) formed therein, and female threads are formed in the inner circumferences of these coupling grooves.

At least two energy storage cells 10 are electrically connected in series or in parallel by respective terminal connection members 20, which will be described later, thereby forming the energy storage module 1 having a large cavity.

The terminal connection member 20 connects an anode terminal 14 or a cathode terminal 14 provided on one of the energy storage cells 10, with an anode terminal 14 or a cathode terminal 14 provided on another energy storage cell 10, which is adjacent to the one energy storage cell 10. Namely, the terminal connection member 20 is coupled with the terminals 14 of the energy storage cells 10, and electrically connects a plurality of the energy storage cells 10 in series and in parallel.

The terminal connection member 20 according to the embodiment is formed by stacking a plurality of metal plates. Further, the terminal connection member 20 includes conductive layers having terminal insertion holes 28 formed in both ends of the terminal connection member 20, and an insulating layer 23 formed on the lower surface of the lowermost conductive layer.

For this, the terminal connection member 20 according to the embodiment includes a first plate 22 disposed on the bottom thereof, and at least one second plate 24 or third plate 26 disposed on the first plate 22.

The first plate 22 has a conductive flat bar shape and includes terminal insertion holes 28 formed at both ends thereof. The lower surface of this first plate 22 is directly in contact with and coupled to the energy storage cells 10. Thus, the insulating layer 23 is formed on the lower surface of the first plate 22 for the insulation of the energy storage cells 10.

The insulating layer 23 is formed on the entire lower surface of the first plate 22, except for the circumferential portions of the terminal insertion holes 28. To obtain the maximum area in which the top surfaces of the terminal 14 and the lower surface of the first plate 22 are in contact with each other, the insulating layer 23 is not formed on the circumferential portions of the terminal insertion holes 28. Through this, the reliability of electrical connection between the terminals 14 and the terminal connection member 20 can be obtained.

In this embodiment, a portion of the upper surfaces of the terminals 14 is not in contact with the lower surface of the first plate 22. However, if the terminals 14 of the energy storage cells 10 are formed such that the terminals 14 are entirely inserted into the terminal insertion holes 28, the insulating layer 23 may be formed on the entire lower surface of the first plate, without removing the insulating layer formed around the circumferential portions of the terminal insertion holes 28.

This insulating layer 23 may be formed in various ways. For example, the insulating layer 23 according to the embodiment may be formed by applying an insulating material to the lower surface of the first plate 22. In this case, it is possible to prevent the insulating layer 23 from being formed on the circumferential portions of the terminal insertion holes 28 by using masking tape, and the like.

Moreover, the insulating layer 23 according to the embodiment may be formed by attaching insulation tape or the like to the lower surface of the first plate 22. In addition to this, the insulating layer 23 may be formed through various methods.

The second plate 24 has the same shape as that of the first plate 22 and is stacked on the first plate 22. That is, the second plate 24 has a conductive flat bar shape and has terminal insertion holes formed at both ends thereof. Thus, the second plate 24 is stacked with the first plate 22 or a third plate 26, which will be described later. Further, the terminal insertion holes 28 of the second plate 24 are formed in the same locations as in the first plate 22, such that the terminal insertion holes 28 of the second plate 24 and the terminal insertion holes 28 of the first plate 22 are aligned vertically, when the first plate 22 and the second plate 24 are stacked.

The third plate 26 is formed to have a shape similar to that of the second plate 24, and has a difference in that a wire coupling portion 27 is provided in the form of protrusion projecting outwardly from the side surface of the third plate 26.

A conductive wire is connected to the wire coupling portion 27 when necessary. Here, the conductive wire is used for electrically connecting a monitoring unit (not shown) which monitors states of the energy storage cells 10, and the terminal connection member 20. For this, the terminal connection member 20 according to this embodiment uses the wire coupling portion 27 formed at the side surface of the third plate 26.

The conductive wire 50 may include a conductive connection part 52 having a cylindrical shape at the end thereof. The connection part 52 has a size allowing for the insertion of the wire coupling portion 27. The connection part 52 is compressed by external pressure in the state in which the wire connecting portion 27 is inserted into the connection part 52, such that the conductive wire 50 and the wire coupling portion 27 are fixedly coupled and electrically connected with each other.

Meanwhile, in this exemplary embodiment, the wire coupling portion 27 is formed on the third plate 26; however, the present invention is not limited to thereto. In other words, the wire coupling portion 27 according to this embodiment may be formed on any one of the first plate 22, the second plate 24, and the third plate 26, which are conductive layers, and the number of the wire coupling portions 27 may be varied in various locations as needed.

The first plate 22, the second plate 24, and the third plate 26 of the terminal connection member 20 according to the embodiment are formed such that center portions between the terminal insertion holes 28 upwardly project to be curved in an arc shape. This is for minimizing areas in which the terminal connection member 2 contacts the storage bodies 12 of the energy storage cells 10. Accordingly, it is possible to minimize short circuits between the storage bodies 12 and the terminal connection member 20.

According to the embodiment, the terminal connection member 20 includes the first plate 22, the second plate 24, and the third plate 26, which are conductive layers and formed of the same material. A conductive metal, particularly copper having high conductivity, may be used as the material of the first plate 22, the second plate 24, and the third plate 26; however, the material is not limited thereto. The first plate 22, the second plate 24, and the third plate 26 may also be formed of different metallic materials. For example, copper may be used for the first plate 22 and the third plate 26, and nickel, aluminum or the like may be used for the second plate 24. Meanwhile, if the first plate 22, the second plate 24, and the third plate 26 are formed of different metallic materials, respective plates may have different thicknesses depending on the material thereof. That is, a high strength plate (e.g., the second plate 24 formed of nickel) may be formed to be thinner than a low strength plate (e.g., the first plate formed of copper), so that manufacturing costs may be reduced.

In the terminal connection member 20 according to this embodiment, the first plate 22, the second plate 24, and the third plate 26 are stacked without being adhered to one another; however, the present invention is not limited thereto. In other words, conductive adhesives may also be interposed between each plate, in order to obtain conductivity between the plates 22, 24, 26.

Furthermore, the terminal connection member 20 according to the embodiment may be used with coating layers formed on the outer surfaces of the first plate 22, the second plate 24, and the third plate 26. In this case, the first plate 22, the second plate 24, and the third plate 26 may be formed of a metallic material, but may also be formed of a nonmetallic material.

Meanwhile, FIGS. 1 to 3 exemplarily show the terminal connection member 20 including the first plate 22, the second plate 24, and the third plate 26. However, the terminal connection member 20 according to the present invention is not limited thereto.

For example, the second plate 24 may be stacked on the first plate 22, and the third plate 26 may be stacked thereon as the uppermost layer. Moreover, only the first plate 22 and the second plate 24 (or the third plate) may be used, without using all of the first plate 22, the second plate 24, and the third plate 26. Further, three or more second plates 24 (or the third plates) may be stacked on the first plate 22.

The fixing members 30 serve to fixedly couple the terminal connection member 20 to the terminals 14 of the energy storage cells 10. Threaded bolts, or the like, may be used. These fixing members 30 penetrate through the terminal insertion holes 28 of the terminal connection member 20 to be inserted into coupling grooves (not shown) formed in the terminals 14 of the energy storage cells 10, thereby being thread coupled with the terminals 14. Through this, the fixing members 30 fixedly couple the terminal connection member 20 to the energy storage cells 10.

The terminal connection member 20 of the energy storage module 1 according to the embodiment, as detailed above, is configured such that a plurality of plates are stacked. Therefore, it is possible to absorb external impact more easily, and prevent the terminal connection member 20 from being broken due to corrosion, and the like.

Moreover, in the terminal connection member 20 according to this embodiment, the insulating layer 23 is formed on the lower surfaces of the first plate 22 contacting the energy storage cells 10. Accordingly, it is possible to prevent short circuits due to contact between the storage bodies 12 of the energy storage cells 10 and the terminal connection member 20, so that a more stable energy storage module 1 may be manufactured.

Furthermore, in the related art, each of the fixing members 30 is generally coupled to a conductive wire 50. Accordingly, in the related art, coupling the conductive wire 50 to the terminal connection member 20 necessarily requires the processes of detaching each fixing member 30 from the conductive wire 50 and re-coupling the conductive wire 50 to the terminal connection member 20.

However, the terminal connection member 20 according to this embodiment uses the wire coupling portion 27 formed at a side surface of at least one of the several plates 22, 24, 26. Thus, the wire coupling portion 27 is inserted into the connection unit 52 having a cylindrical shape, and then the conductive wire 52 is compressed such that the conductive wire 50 may be fixedly coupled to the wire coupling portion 27. Through this, it may reduce the time for coupling the conductive wire 50.

As explained above, the terminal connection member 20 of the energy storage module 1 according to the present invention is not limited to the foregoing embodiment, and may also be realized in various manners.

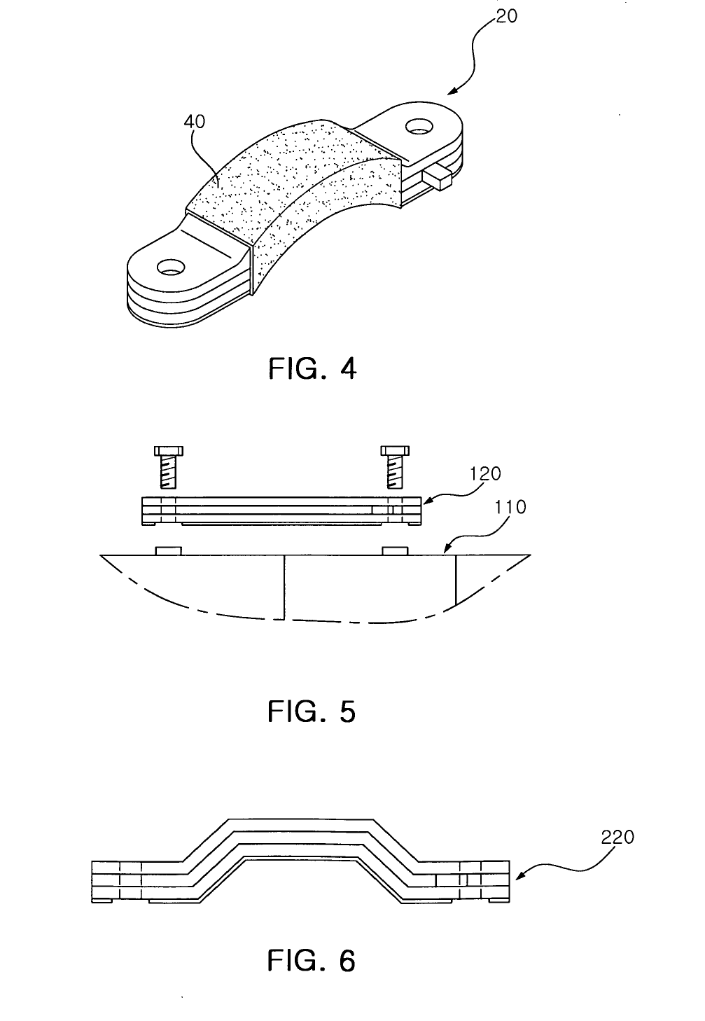

FIG. 4 is a perspective view showing a terminal connection member of an energy storage module according to another exemplary embodiment of the present invention.

Referring to FIG. 4, the terminal connection member 20 according to the embodiment is configured in the same manner as the terminal connection member 20 of FIG. 1, and merely has a difference in that an insulation cover is further included on the outside of the terminal connection member 20.

The insulation cover 40 is formed to cover a center portion of the terminal connection member 20. The insulation cover 40 is made of an insulating material, and may be made of an elastic rubber. However, the insulation cover 40 according to the embodiment is not limited thereto, and any various materials capable of insulating the terminal connection member 120 from the outside, such as fabrics, resins, and the like may be used.

When the insulation cover 40 is included in the terminal connection member 20, as in the embodiment, it may prevent short circuits between the terminal connection member 20 and the storage bodies (12 of FIG. 1) of the energy storage cells (10 of FIG. 1), more efficiently.

FIGS. 5 and 6 are respectively, cross sectional views showing the terminal connection member of the energy storage module according to another embodiment of the present invention.

Referring to FIG. 5, the terminal connection member 120 according to the embodiment has a similar configuration to the terminal connection member 20 according to the embodiment of FIG. 1, and merely has a difference in that center portions of the terminal connection member 120 are made to be flat, rather than being curved in an arc shape.

Moreover, the terminal connection member 220 according to the embodiment shown in FIG. 6 is configured to be similar to the terminal connection member 20 according to the embodiment of FIG. 1, and merely has a difference in that center portions of the terminal connection member 220 are bent in the form of a trapezoid.

Like this, the terminal connection member according to the present invention is variously applicable to any configurations in which the insulation between the storage bodies of the energy storage cells and the terminal connection member could be obtained.

The energy storage module according to the present invention as detailed above is not limited to the foregoing embodiments, and various modifications may be made by a person having ordinary skill in the art within the technical spirit of the present invention.

Also, the embodiment exemplarily explains the terminal connection member included in the energy storage module, but which is not limited to the example set forth herein, and the terminal connection member is variously applicable to any kinds of modules configured by electrically connecting a plurality of terminals.

As set forth above, in the terminal connection member of the energy storage module according to exemplary embodiments of the invention, a plurality of plates, rather than a single plate, are stacked. Thus, it is possible to absorb external impact more easily, and prevent the terminal connection member from being broken due to corrosion, and the like.

Moreover, in the terminal connection member according to the present invention, the insulating layer is formed on the lower surface of the first plate adjacent to the energy storage cells. Accordingly, it may prevent short circuits due to the contacts between the storage bodies of the energy storage cells and the terminal connection member, so that a stable energy storage module may be manufactured.

Moreover, the terminal connection member according to the present invention uses the wire coupling portion formed at a side surface of at least one of the several plates. Thus, the wire coupling portion is inserted into the end of the conductive wire formed to have a cylindrical shape, then the end of the conductive wire is compressed, and thereby the conductive wire may be coupled to the wire coupling portion, so that it may reduce the time for coupling the conductive wire.

While the present invention has been shown and described in connection with the exemplary embodiments, it will be apparent to those skilled in the art that modifications and variations can be made without departing from the spirit and scope of the invention as defined by the appended claims.

What is claimed is:

1. An energy storage module comprising:
terminal connection members, each including a first plate having a conductive flat bar shape and including terminal insertion holes formed in both ends thereof and at least one second plate having the same shape as the first plate and stacked on the first plate, wherein the first plate has an insulating layer formed on a lower surface thereof; and,
at least two energy storage cells having terminals inserted into the terminal insertion holes of the terminal connection members and electrically connected to each other in series or in parallel by the terminal connection members.

2. The energy storage module of claim 1, wherein the insulating layer is formed on the entire lower surface of the first plate, except for circumferential portions of the terminal insertion holes.

3. The energy storage module of claim 2, wherein the insulating layer is formed by applying an insulating material to the lower surface of the first plate.

4. The energy storage module of claim 2, wherein the insulating layers is formed by attaching insulation tape to the lower surface of the first plate.

5. The energy storage module of claim 2, wherein the first and second plates are formed of different metallic materials.

6. The energy storage module of claim 2, wherein the first and second plates are formed such that center portions between the terminal insertion holes upwardly project to be curved in an arc shape.

7. The energy storage module of claim 2, further comprising an insulation cover surrounding the center portions of the first and second plates.

8. The energy storage module of claim 2, further comprising at least one third plate having a similar shape to the second plate and interposed between the first plate and the second plate.

9. The energy storage module of claim 8, further comprising a wire coupling portion in the form of protrusion projecting outwardly from at a side surface of at least one of the first plate, the second plate, and the third plate.

10. The energy storage module of claim 1, further comprising fixing members which fixedly couple the terminal connection member with the terminals.
